(19) United States
(12) Patent Application Publication
(10) Pub. No.: US 2006/0026654 A1
(43) Pub. Date: Feb. 2, 2006

(54) Live content management method, source device, and sink device

(75) Inventors: Cheol-hong An, Suwon-si (KR); In-hwan Kim, Suwon-si (KR); Alexandre Magzoumov, Suwon-si (KR); Ju-han Lee, Suwon-si (KR); Ho-jeong You, Suwon-si (KR); Jun-hae Choi, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/155,589

(22) Filed: Jun. 20, 2005

(30) Foreign Application Priority Data
Jul. 27, 2004 (KR) 10-2004-0058784

(51) Int. Cl. H04N 7/173; H04N 7/16

(52) U.S. Cl. 725/89; 725/134; 725/145

(57) ABSTRACT

A live content management method, a source device, and a sink device are provided. The live content management method includes storing live content in a storage unit of a source device if the transmission of the live content from the source device to a sink device is temporarily stopped. The live content management method may also include transmitting the live content stored in the storage unit of the source device to the sink device and then transmitting live content currently being broadcasted to the sink device via the storage unit of the source device, when receiving a request for resuming the transmission of the live content stored in the storage unit of the source device before a time-out for a command to stop the transmission of the live content stored in the storage unit of the source device. Accordingly, it is possible to provide various data transmission scenarios for a home network environment by efficiently managing live content even when the transmission of the live content via a home network has been temporarily stopped.

### BACKGROUND OF THE INVENTION

This application claims the benefit of Korean Patent Application No. 10-2004-0058784, filed on Jul. 27, 2004, in the Korean Intellectual Property Office, the disclosure of which is incorporated herein in its entirety by reference.

1. Field of the Invention

The present invention relates to management of live content via a network, and more particularly, to a live content management method, a source device, and a sink device.

2. Description of the Related Art

Due to the advent and advance of the digital era, an increasing number of digital products, such as DVD players, cable set-top boxes, digital VCRs, digital TVs, and PCs, are being produced. In accordance with the trend of manufacturing digital products to be connectible to a single network, the Digital Home Working Group (DHWG) has established various home network standards for controlling the connection of various digital products to a network.

Today, a home network environment for multimedia is divided into three domains, i.e., a PC Internet world, a mobile world, and a consumer electronics (CE) broadcast world.

FIG. 1 is a diagram illustrating a conventional digital home network environment established based on DHWG guidelines.

A PC Internet world 100 consists of a PC 101 and PC peripherals, i.e., a game console 102, a printer 103, a digital imaging device 104, a digital music device 105, and a wireless monitor 106.

A mobile world 110 consists of mobile devices, i.e., a laptop computer 111, a multimedia mobile phone 112, and a personal digital assistant (PDA) 113. The mobile devices provide users with the freedom of movement into or out of a home network.

A CE broadcast world 120 consists of a TV monitor 121, a consumer electronics device 122, such as a personal video recorder (PVR), a tuner, or an STB, and a stereo set 123.

Consumers want digital devices in the three digital worlds to work together in a home network. Therefore, it is necessary to carry out research on a home network that realizes the interoperability of digital devices belonging to different digital words.

A digital home network consists of a CE network, a mobile network, and a PC network and is based on IP networking and universal plug and play (UPnP) technologies. The CE network, the mobile network, and the PC network of the digital home network should cooperate with one another to achieve transparent, simple, and seamless interoperability thereamong.

Media management and control based on UPNP audio/video (A/V) technology enables digital devices and applications to identify, manage, and distribute media content over a home network and to transmit the media content to mobile devices over the home network.

UPnP is an architecture for peer-to-peer network connection of intelligent applications, wireless devices, and PCs and is versatile and easy to use in a small-size network, for example, home or small business, and is designed to provide a connection based on the standard. The UPnP architecture defines general interaction between a UPnP control point and UPnP devices. The UPnP architecture allows UPnP devices to support content and transmission protocols in many forms. The UPnP devices include a TV, a VCR, a compact disc (CD)/DVD player, an STB, a stereo system, a Motion Picture Experts Group (MPEG) audio layer 3 (MP3) player, a still camera, a camcorder, a PC, and so on. An AV architecture allows devices to support content of different formats (e.g., MPEG2, MPEG4, Joint Photographic Experts Group (JPEG), MP3, bitmap (BMP), and Window media architecture (WMA)) and transmission protocols of various types (e.g. Institute of Electrical and Electronics Engineers (IEEE)-1394, Hyper Text Transfer Protocol (HTTP) GET, Live Transport Protocol (RTP), HTTP PUT/POST, and Transmission Control Protocol (TCP)/IP).

The majority of UPnP AV scenarios include transmitting content (e.g., movies, music, and pictures) from one device to another device. An AV control point interacts with at least two UPnP devices that act as a source and a sink.

A media server has content a user wants to render. The media server may include or access a plurality of content. The media server accesses the plurality of content and transmits them to another device via a network, using a predetermined transmission protocol. Examples of the media server include, a VCR, a CD/DVD player, a camera, a camcorder, a PC, an STB, a satellite receiver, an audio tape player, and so on.

A media server control point controls and manages the media server according to a user's preference so as to make the media server perform an operation (e.g., data reproduction) desired by the user. Also, the media server control point provides a user interface so that the user can interact with devices to control the devices. Examples of the media server control point include, a TV having a general remote control, and a wireless PDA device. In addition, when required by the user, the media server control point may control the flow of content by invoking various AV transmission actions such as ‘stop’, ‘pause’, ‘fast forward’, ‘rewind’, and ‘skip’.

In a case where the transmission of the live content in the home network environment of FIG. 1 is temporarily stopped, it is necessary to efficiently manage the live content until the transmission of the live content is resumed.

### SUMMARY OF THE INVENTION

The present invention provides a live content management method, a source device, and a sink device, which manage live A/V content via a network.

According to an aspect of the present invention, there is provided a live content management method, which manages live content via a network. The live content management method includes storing live content in a storage unit of a source device if the transmission of the live content from the source device to a sink device is temporarily stopped.

The live content management method may also include transmitting the live content stored in the storage unit of the source device to the sink device and then transmitting live content currently being broadcasted to the sink device via the storage unit of the source device, when receiving a request for resuming the transmission of the live content stored in the storage unit of the source device before a time-out for a command to stop the transmission of the live content stored in the storage unit of the source device.

The live content management method may also include transmitting to the sink device information on whether the state of the live content stored in the storage unit of the source device has been changed.

The live content management method may also include transmitting live content currently being broadcasted directly to the sink device when receiving a request for transmitting the live content currently being broadcasted after a time-out for a command to stop the transmission of the live content stored in the storage unit of the source device.

The request for transmitting the live content currently being broadcasted may be transmitted using an HTTP GET command.

The live content management method may also include transmitting the live content stored in the storage unit of the source device to the sink device and then transmitting live content currently being broadcasted to the sink device via the storage unit of the source device when receiving a request for transmitting the live content stored in the storage unit of the source device after a time-out for a command to stop the transmission of the live content stored in the storage unit of the source device.

The request for transmitting the live content stored in the storage unit of the source device may be transmitted using an HTTP GET command with a predetermined range specified therein.

The live content management method may also include transmitting an error message or the live content currently being broadcasted to the sink device if the live content stored in the storage unit of the source device is outside the predetermined range.

The live content management method may also include transmitting the live content stored in the storage unit of the source device to the sink device by performing a trick play when receiving, from the sink device, a request for resuming the transmission of the live content stored in the storage unit of the source device after a time-out for a command to stop the transmission of the live content stored in the storage unit of the source device.

The transmitting the live content stored in the storage unit of the source device to the sink device, may include receiving one or more HTTP GET commands with a range specified therein from the sink device and transmitting live content corresponding to the range to the sink device more than one time in response to the HTTP GET command(s).

According to another aspect of the present invention, there is provided a live content management method, which manages live content via a network. The live content management method includes issuing to a source device a request for temporarily stopping the transmission of live content so that the transmission of the live content can be temporarily stopped and the live content can be stored in the source device.

The live content management method may also include: issuing to the source device a request for resuming the transmission of the live content stored in the source device before a time-out for a command to temporarily stop the transmission of the live content; and receiving the live content stored in the source device in response to the request for resuming the transmission of the live content stored in the source device.

The live content management method may also include receiving information on whether the state of the live content stored in the source device has been changed from the source device.

The live content management method may also include issuing to the source device a request for transmitting live content currently being broadcasted after a time-out for a command to stop the transmission of the live content stored in the source device and receiving the live content currently being broadcasted directly from the source device.

The request for transmitting the live content currently being broadcasted may be issued using an HTTP GET command.

The live content management method may also include issuing to the source device a request for transmitting the live content stored in the source device after a time-out for a command to stop the transmission of the live content stored in the source device and receiving the live content stored in the storage unit of the source device and then live content currently being broadcasted from the source device.

The request for transmitting the live content stored in the source device may be issued using an HTTP GET command with a predetermined range specified therein.

The live content management method may also include receiving an error message or the live content currently being broadcasted from the source device if the live content stored in the storage unit of the source device is outside the predetermined range.

The live content management method may also include issuing to the source device a request for transmitting the live content stored in the source device after a time-out for a command to stop the transmission of the live content stored in the source device and receiving the live content stored in the source device from the source device through a trick play.

The issuing to the source device the request for transmitting the live content stored in the source device, may include transmitting one or more HTTP GET commands with a range specified therein to the source device and receiving live content corresponding to the range from the source device more than one time in response to the HTTP GET command(s).

The issuing to the source device the request for transmitting the live content stored in the source device, may include transmitting an HTTP GET command with the trick play specified therein to the source device and receiving the live content stored in the source device from the source device through the trick play.

According to another aspect of the present invention, there is provided a source device which manages live content via a network. The source device includes a controller, which stores live content in a storage unit of a source device if the transmission of the live content from the source device to a sink device is temporarily stopped.

According to another aspect of the present invention, there is provided a sink device which manages live content via a network. The sink device includes a controller, which issues to a source device a request for temporarily stopping the transmission of live content so that the transmission of the live content can be temporarily stopped and the live content can be stored in the source device.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional home network set up based on the DHWG guidelines;

FIG. 2 is a block diagram of a system for managing live content via a network, according to an exemplary embodiment of the present invention;

FIG. 3 is a detailed block diagram of the source device of FIG. 2;

FIG. 4 is a detailed block diagram of the sink device of FIG. 2;

FIG. 5 is a flowchart of an example of interaction between a source device and a sink device according to exemplary embodiments of the present invention;

FIG. 6 is a flowchart of another example of the interaction between the source device and the sink device;

FIG. 7 is a flowchart of another example of the interaction between the source device and the sink device;

FIG. 8 is a flowchart of another example of the interaction between the source device and the sink device;

FIG. 9 is a flowchart of another example of the interaction between the source device and the sink device;

FIG. 10 is a diagram illustrating an example of an HTTP GET command;

FIG. 11 is a diagram illustrating an example of a pause command;

FIG. 12 is a diagram illustrating an example of a resume command;

FIG. 13 is a diagram illustrating an example of another HTTP GET command with a range specified therein;

FIG. 14 is a diagram illustrating an example of still another HTTP GET command with playspeed specified therein.

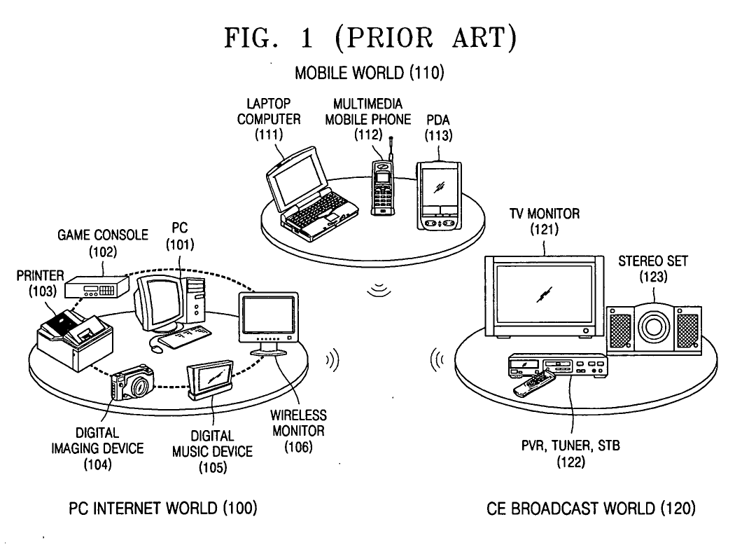

### DETAILED DESCRIPTION OF THE INVENTION

The present invention will now be described more fully with reference to the accompanying drawings, in which exemplary embodiments of the invention are shown.

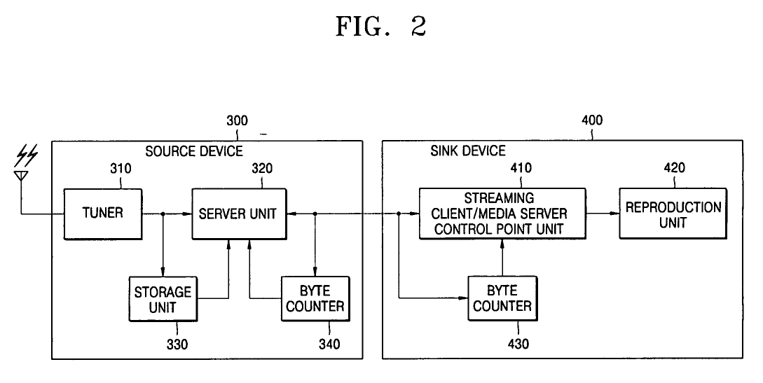

FIG. 2 is a block diagram of a system for managing live content via a network, according to an exemplary embodiment of the present invention. Referring to FIG. 2, the system includes a source device 300 and a sink device 400. The source device 300 receives a request for live content from the sink device 400 and transmits the live content to the sink device 400. The sink device obtains information on the live content from the source device 300, issues the request for the live content to the source device 300, receives the live content from the source device 300, and consumes the live content.

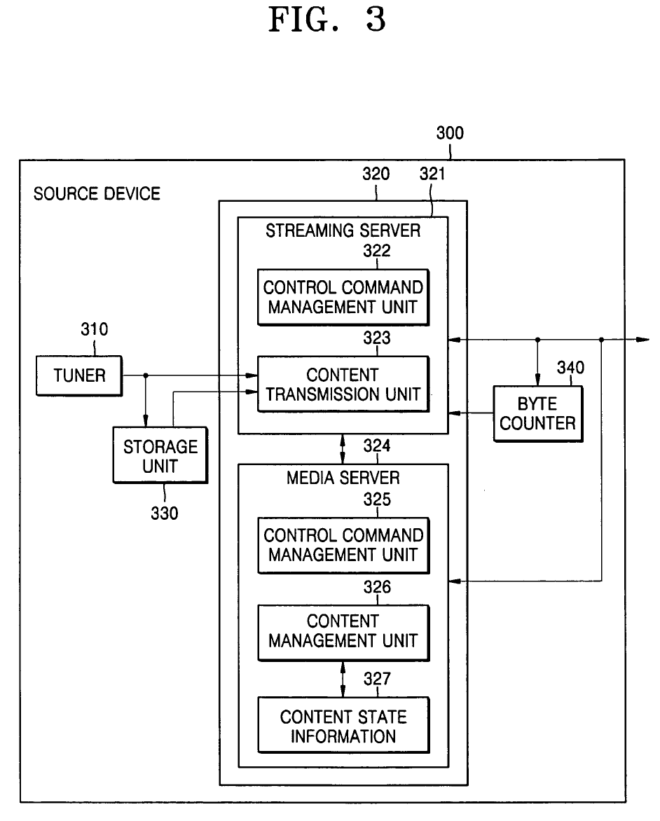

The source device 300 includes a tuner 310, a server unit 320, which comprises a streaming server (321 of FIG. 3) and a media server (324 of FIG. 3), a storage unit 330, and a byte counter 340.

In the server unit 320, the streaming server provides the sink device 400 with live content, and a media server provides the sink device with information on the live content.

Particularly, the streaming server provides live content received from the tuner 310 to the sink device 400, or reads live content from the storage unit 330 and then provides the read live content to the sink device 400.

The storage unit 330 stores live content if the live content cannot be transmitted to the sink device 400 via a network.

The byte counter 340 counts the number of live contents that have been transmitted to the sink device 400 or counts time information of each of the transmitted live contents.

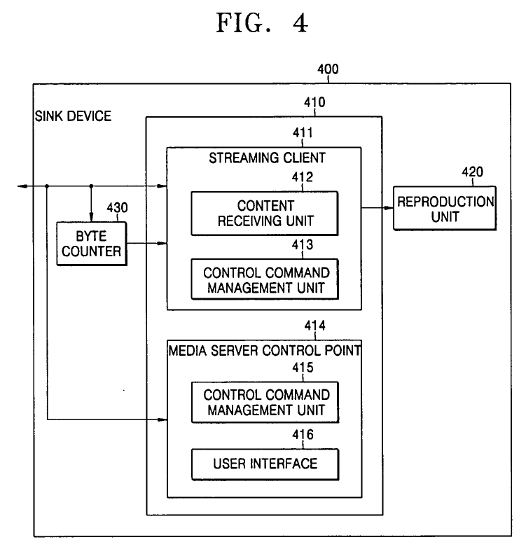

The sink device 400 includes a streaming client/media server control point unit 410, which comprises a streaming client (411 of FIG. 4) and a media server control point (414 of FIG. 4), a reproducer 420, and a byte counter 430. The sink device 400 consumes A/V content received from the source device 300. For example, if a user issues a command to play predetermined data to the sink device 400, the sink device 400 reads the predetermined data from the source device 300 using HTTP protocol.

In the streaming client/media server control point unit 410, the media server control point obtains information on live content from the source device 300 and performs its operations according to a command issued by a user, and the streaming client transmits a control command to the source device 300 and receives the live content from the source device 300.

The byte counter 430 counts the number of data that have been received from the source device 300 or calculates time information of each of the received data.

The reproducer 420 receives live content from the streaming client and reproduces the received live content.

FIG. 3 is a detailed block diagram of the source device 300 of FIG. 2. More specifically, FIG. 3 illustrates in greater detail the structure of the server unit 320 of the source device 300.

Referring to FIG. 3, the server unit 320 includes the streaming server 321 and the media server 324.

The media server 324 includes a control command management unit 325, a content management unit 326, and content state information 327.

The control command management unit 325 generates a control command and transmits the control command to the sink device 400. In addition, the control command management unit 325 receives a control command from the sink device 400, interprets the received control command, and performs its operations based on the interpretation result. More specifically, the control command management unit 325 receives, for example, a ‘browse’ or ‘search’ command, from the sink device 400, interprets the ‘browse’ or ‘search’ command, and controls the content management unit 326 based on the interpretation result to transmit state information of content of interest to the sink device 400.

The content management unit 326 manages state information of various contents, i.e., the content state information 327. In other words, when the content management unit 326 receives a request for information on content from the media server control point of the sink device 400, it searches for the requested content information and transmits the requested content information to the sink device 400. In a case where live content received from the tuner 310 is stored in the storage unit 330, the content management unit 326 modifies content state information corresponding to the live content, specifying whether the live content is seekable or whether the live content is trick-playable. Then, the content management unit 326 informs the sink device 400 of the modification of the content state information corresponding to the live content by transmitting, for example, an event message, to the sink device 400. The control command management unit 325 and the content management unit 326 operate under control of a controller (not shown).

The streaming server 321 includes a control command management unit 322 and a content transmission unit 323.

The control command management unit 322 receives from the sink device 400 a control command for content requested by the sink device 400, interprets the received control command, and controls the content transmission unit 323 based on the interpretation result. Here, the control command for the content requested by the sink device 400 includes ‘play’, ‘pause’, ‘resume’, ‘FF’, and ‘RW’.

The content transmission unit 323 receives live content requested by the sink device 400 from the tuner 310 and then transmits the received live content to the sink device 400. Alternatively, the content transmission unit 323 reads the requested live content from the storage unit 330 and then transmits the live content read out from the storage unit 330 to the sink device 400. In the case of transmitting the requested live content read out from the storage unit 330, the content transmission unit 323 searches the storage unit 330 for a predetermined range of content with reference to information provided by the byte counter 340, i.e., with reference to the number of contents that have been transmitted to the sink device or time information of each of the transmitted contents.

The byte counter 340 calculates the number of contents that have been transmitted to the sink device or the time information of each of the transmitted contents and provides the number of contents that have been transmitted to the sink device or the time information of each of the transmitted contents to the content transmission unit 323.

The control command management unit 322, the content transmission unit 323, and the byte counter 340 operate under control of the controller.

FIG. 4 is a detailed block diagram of the sink device 400 of FIG. 2. More specifically, FIG. 4 illustrates in greater detail the structure of the streaming client/media server control point unit 410 of the sink device of FIG. 2. Referring to FIG. 4, the streaming client/media server control point 410 includes the streaming client 411 and the media server control point 414.

The media server control point 414 includes a control command management unit 415 and a user interface 416.

The user interface 416 receives a control operation command for A/V content of interest, e.g., ‘play’, from a user and transmits the received control operation command to the control command management unit 415.

The control command management unit 415 issues a request for information on the A/V content of interest to the source device 300 by transmitting a ‘browse’ or ‘search’ command to the source device 300. When receiving the requested A/V content information from the source device 300, the control command management unit 415 interprets the received A/V content information and transmits the interpretation result or information on the control operation command received from the user via the user interface to the streaming client 411. When receiving from the source device 300 an event message indicating that state information of the A/V content of interest has been modified, the control command management unit 415 issues to the source device 300 a request for information on modifications made to the state information of the A/V content of interest and receives the requested information from the source device 300. The control command management unit 415 and the user interface 416 operate under control of a controller (not shown).

The streaming client 411 includes a control command management unit 415 and a A/V content receipt unit 412.

The control command management unit 413 generates a control command for the A/V content of interest by referring to information received from the media server control point 414, i.e., the information on the control operation command received from the user or the result of interpreting the information on the AN content of interest, and then transmits the control command to the source device 300. The control command management unit 413 may transmit an HTTP GET command, a ‘pause’ command, or a ‘resume’ command to the source device 300 in order to fetch the A/V content of interest from the source device 300 or may transmit another HTTP GET command with a range of A/V content to be fetched from the source device 300 specified therein or still another HTTP GET command with playspeed specified therein to the source device 300 in order to perform a trick play.

The content receipt unit 412 receives the A/V content of interest from the source device 300 and then transmits the received A/V content of interest to the reproducer 420. The control command management unit 413, the content receipt unit 412, and the byte counter 430 operate under control of the controller (not shown).

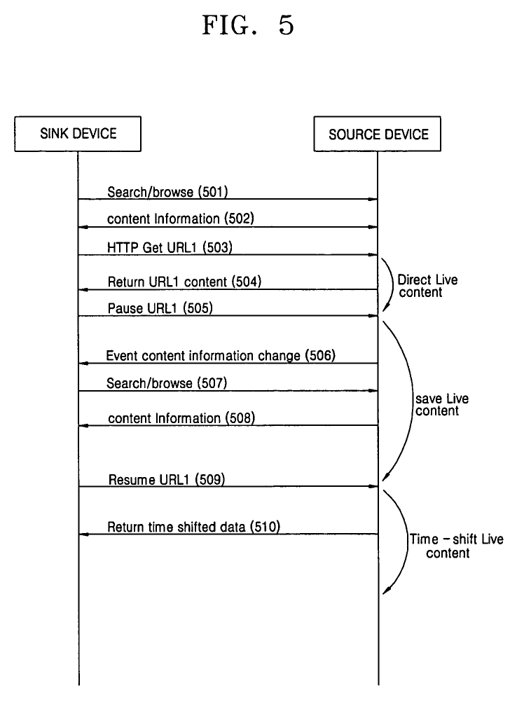

FIG. 5 is a flowchart illustrating an example of interaction between a sink device and a source device according to exemplary embodiments of the present invention. Referring to FIG. 5, in a case where no time-out occurs for a ‘pause’ command issued to the source device by the sink device, the source device resumes the transmission of live content, which has been temporarily stopped in response to the ‘pause’ command.

More specifically, in operation 501, the sink device issues a ‘browse’ or ‘search’ command to the source device in order to obtain information on content of interest.

In operation 502, the source device transmits the requested content information to the sink device in response to the receipt of the ‘browse’ or ‘search’ command.

In operation 503, the sink device issues an HTTP GET command with URL1 specified therein (hereinafter, referred to as HTTP GET URL1 command) to the source device. In operation 504, the source device transmits content corresponding to URL1 to the sink device. Here, the content transmitted from the source device is live data directly transmitted from a tuner of the source device.

An example of the HTTP GET URL1 command is illustrated in FIG. 10. Referring to FIG. 10, the HTTP GET URL1 command contains a request for searching for information identified by URL1. In the HTTP GET URL1 command, a ‘HOST’ field specifies information identifying an Internet host. The ‘HOST’ field contains ‘host of control URL1’ and ‘port of control URL1’. ‘Play’ is set in an ‘ACTION’ field of the HTTP GET URL1 command.

If the sink device issues a ‘pause’ command to the source device to temporarily stop the source device from transmitting the content corresponding to URL1 in operation 505, the source device stores the content corresponding to URL1 in its storage unit. Here, the ‘pause’ command is a command to temporarily stop the transmission of the content corresponding to URL1. An example of the ‘pause’ command, particularly, an HTTP POST command, is illustrated in FIG. 11. In operation 505, the sink device may issue to the source device a control command, other than the HTTP POST command, to the source device.

In operation 506, the source device changes the state of the content corresponding to URL1 into a seekable or trick-playable state and informs the sink device of the modification of the state of the content corresponding to URL1 by transmitting an event message to the sink device.

In operation 507, the sink device realizes that the state of the content corresponding to URL1 has been changed and issues a ‘browse’ or ‘search’ command to the source device. In operation 568, the sink device updates state information of the content corresponding to URL1 based on the change of the state of the content corresponding to URL1.

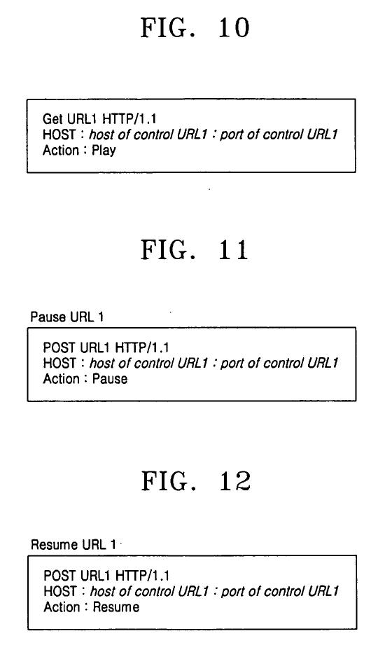

If the sink device issues a ‘resume’ command for the command corresponding to URL1 to the source device before a pause time-out in operation 509, the source device stores data currently being input from the tuner of the source device in the storage unit and transmits data that used to be stored in the storage unit, i.e., time-shifted data, to the sink device in operation 510. Here, the ‘resume’ command is a command to resume the transmission of the content corresponding to URL1, which has been temporarily stopped. An example of the ‘resume’ command is illustrated in FIG. 12. In operation 510, the storage unit may transmit a control command, other than the ‘resume’ command, to the sink device. Here, the pause time-out may occur in the source device or the sink device due to the source or sink device's internal or external factor or may be arbitrarily generated by the source device or the sink device.

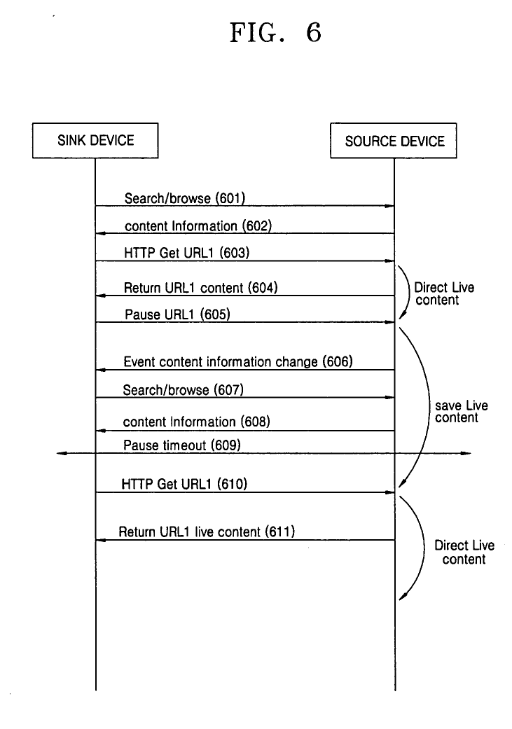

FIG. 6 is a flowchart of another example of the interaction between the sink device and the source device according to the exemplary embodiments of the present invention. Referring to FIG. 6, in a case where a time-out occurs for a ‘pause’ command issued to the source device by the sink device, the source device resumes the transmission of live content, which has been temporarily stopped in response to the ‘pause’ command.

More specifically, in operation 601, the sink device issues a ‘browse’ or ‘search’ command to the source device. In operation 602, the sink device receives information on live content of interest from the source device. In operation 603, the sink device issues an HTTP GET URL1 command to the source device in order to fetch live content corresponding to URL1 from the source device. In operation 604, the sink device receives the live content corresponding to URL1 from the source device. In operation 605, the source device stops transmitting the live content corresponding to URL1 in response to a ‘pause’ command. In operation 606, the source device notifies the sink device of the change of the state of the live content corresponding to URL1. Operations 607 and 608 are the same as their respective counterparts of FIG. 5, i.e., operations 507 and 508. In other words, in operation 607, the sink device realizes that the state of the live content corresponding to URL1 has been changed and issues a ‘browse’ or ‘search’ command to the source device. In operation 608, the sink device updates state information of the live content corresponding to URL1 based on the change of the state of the live content corresponding to URL1.

In operation 609, a pause timeout occurs in the sink device or the source device for some reason. Sometimes, the sink device may want to receive data currently being broadcasted, rather than data stored in the storage unit of the source device. In this case, in operation 610, the sink device issues another HTTP GET URL1 command to the source device. In operation 611, the source device transmits the data currently being broadcasted to the sink device in response to the HTTP GET URL1 command issued in operation 610.

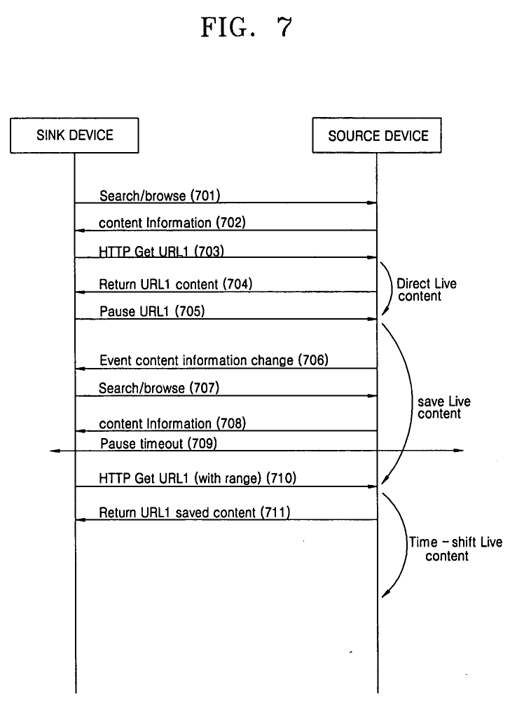

FIG. 7 is a flowchart of another example of the interaction between the sink device and the source device according to the exemplary embodiments of the present invention. Referring to FIG. 7, in a case where a time-out occurs for a ‘pause’ command issued to the source device by the sink device, the source device stops transmitting live content currently being transmitted to the sink device in response to the ‘pause’ command and then transmits live content stored in its storage unit to the sink device.

More specifically, in operation 701, the sink device issues a ‘browse’ or ‘search’ command to the source device. In operation 702, the sink device receives information on live content of interest from the source device. In operation 703, the sink device issues an HTTP GET URL1 command to the source device in order to fetch live content corresponding to URL1 from the source device. In operation 704, the sink device receives the live content corresponding to URL1 from the source device. In operation 705, the source device stops transmitting the live content corresponding to URL1 in response to a ‘pause’ command. In operation 706, the source device notifies the sink device of the change of the state of the live content corresponding to URL1. In operation 707, the sink device realizes that the state of the live content corresponding to URL1 has been changed and issues a ‘browse’ or ‘search’ command to the source device. In operation 708, the sink device updates state information of the live content corresponding to URL1 based on the change of the state of the live content corresponding to URL1. Operations 701 through 708 are the same as their respective counterparts of FIG. 6, i.e., operations 601 through 608.

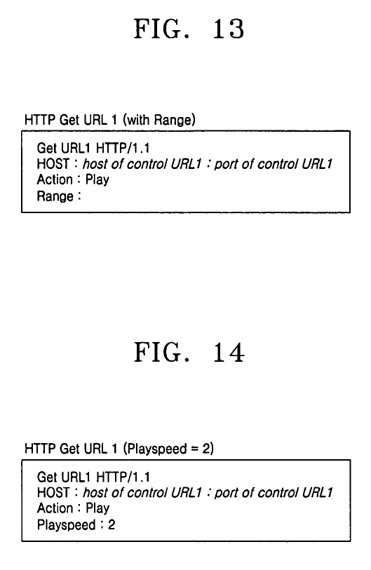

In operation 709, a pause timeout occurs in the sink device or the source device for some reason. Sometimes, the sink device may want to receive data stored in the storage unit of the source device, rather than data currently being broadcasted. In this case, in operation 710, the sink device transmits another HTTP GET URL1 command to the source device together with range information or time information of live content that it wishes to fetch from the storage unit of the source device. The range information or the time information indicates the location of the live content that the sink device wishes to fetch from the storage unit of the source and is provided by a byte counter of the sink device. An example of the HTTP GET URL1 command with a range specified therein is illustrated in FIG. 13.

In operation 711, the source device transmits the data requested by the sink device by referring to the range information or the time information received from the sink device. If the range information is inaccurate such that the source device fails to search its storage unit for the data requested by the sink device, the source device transmits an error message to the sink device. If the range information only designates a start point, failing to specify an end point, the source device transmits data within a range from the start point to the end of the storage unit and then resumes the transmission of the live content corresponding to URL1. The source device can identify how much of the live content corresponding to URL1 had been transmitted to the sink device before the ‘pause’ command by referring to the byte counter.

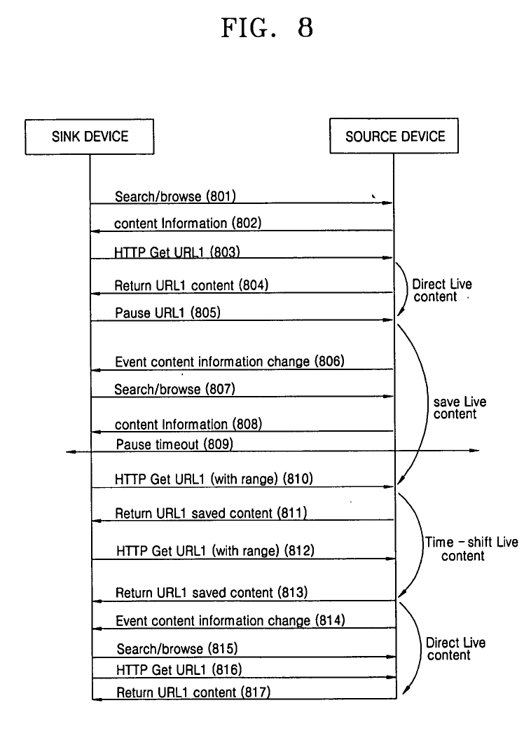

FIG. 8 is a flowchart of another example of the interaction between the sink device and the source device according to the exemplary embodiments of the present invention. Referring to FIG. 8, in a case where a time-out occurs for a ‘pause’ command issued to the source device by the sink device, the source device stops transmitting live content currently being transmitted to the sink device in response to the ‘pause’ command, and the source device provides live content to the source device a plurality of number of times in response to a plurality of requests issued by the sink device.

More specifically, in operation 801, the sink device issues a ‘browse’ or ‘search’ command to the source device. In operation 802, the sink device receives information on live content of interest from the source device. In operation 803, the sink device issues an HTTP GET URL1 command to the source device in order to fetch live content corresponding to URL1 from the source device. In operation 804, the sink device receives the live content corresponding to URL1 from the source device. In operation 805, the source device stops transmitting the live content corresponding to URL1 in response to a ‘pause’ command. In operation 806, the source device notifies the sink device of the change of the state of the live content corresponding to URL1. In operation 807, the sink device realizes that the state of the live content corresponding to URL1 has been changed and issues a ‘browse’ or ‘search’ command to the source device. In operation 808, the sink device updates state information of the live content corresponding to URL1 based on the change of the state of the live content corresponding to URL1. Operations 801 through 808 are the same as their respective counterparts of FIG. 6, i.e., operations 601 through 608.

In operation 809, a pause timeout occurs in the sink device or the source device for some reason. The sink device transmits several HTTP GET URL1 commands with different ranges specified therein to the source device in order to receive live content from the source device in a plurality of steps.

More specifically, in operation 810, the sink device transmits an HTTP GET URL1 command with a first range specified therein to the source device. In operation 811, the sink device receives live content corresponding to the first range from the source device. In operation 812, the sink device transmits another HTTP GET URL1 command with a second range specified therein to the source device. In operation 813, the sink device receives live content corresponding to the second range from the source device. Operations 810 through 813 may be performed in order for the sink device to perform a trick play. If the end of a range specified in an HTTP GET URL1 command transmitted from the sink device to the source device in any stage designates the end of data stored in the storage unit, the source device transmits live content corresponding to the range to the sink device, changes the state of the live content corresponding to URL1 into a non-seekable or non-trick playable state, and informs the sink device of the change of the state of the live content corresponding to URL1 in operation 814 by transmitting an event message to the sink device. In operation 815, the sink device receives the event message from the source device, transmits another ‘browse’/‘search’ command to the source device in order to obtain information on how the state of the live content corresponding to URL1 has been changed, and receives the information from the source device. In operation 816, the sink device issues to the source device a request for transmitting live content in a regular reproduction mode by executing another HTTP GET URL1 command. In operation 817, the source device transmits the live content to the sink device in response to the request issued thereto by the sink device in operation 816.

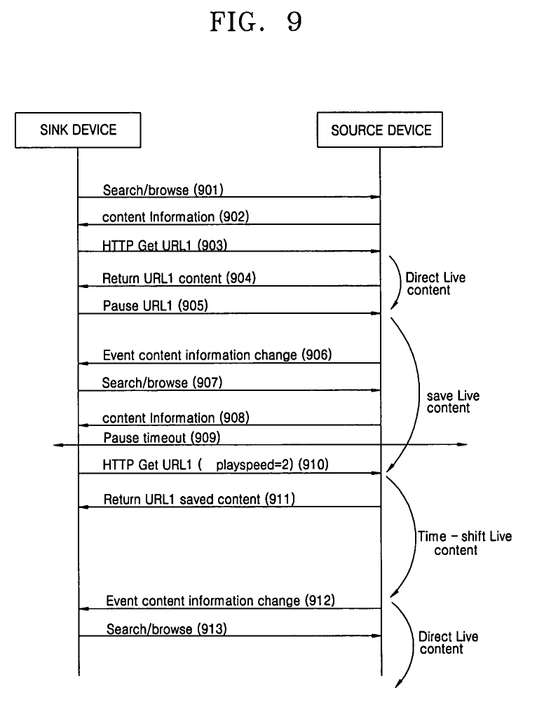

FIG. 9 is a flowchart of another example of the interaction between the source device and the sink device according to the exemplary embodiments of the present invention. Referring to FIG. 9, when a time-out occurs for a ‘pause’ command issued to the source device by the sink device, the source device provides live content to the sink device several times by performing a trick play requested by the sink device.

More specifically, in operation 901, the sink device issues a ‘browse’ or ‘search’ command to the source device. In operation 902, the sink device receives information on live content of interest from the source device. In operation 903, the sink device issues an HTTP GET URL1 command to the source device in order to fetch live content corresponding to URL1 from the source device. In operation 904, the sink device receives the live content corresponding to URL1 from the source device. In operation 905, the source device stops transmitting the live content corresponding to URL1 in response to a ‘pause’ command. In operation 906, the source device notifies the sink device of the change of the state of the live content corresponding to URL1. In operation 907, the sink device realizes that the state of the live content corresponding to URL1 has been changed and issues a ‘browse’ or ‘search’ command to the source device. In operation 908, the sink device updates state information of the live content corresponding to URL1 based on the change of the state of the live content corresponding to URL1. Operations 901 through 908 are the same as their respective counterparts of FIG. 6, i.e., operations 601 through 608.

In operation 909, a pause timeout occurs in the sink device or the source device for some reason. Here, the source device supports a trick play. In operation 910, the sink device issues to the source device a request for transmitting the live content corresponding to URL1 at a two times higher speed than the speed currently offered by the source device by transmitting an HTTP GET URL1 command with playspeed specified therein to the source device after the time-out. An example of the HTTP GET URL1 command transmitted from the sink device to the source device in operation 910 is illustrated in FIG. 14.

In operation 911, the source device transmits the live content corresponding to URL1 to the sink device at a two times higher speed than its current transmission speed or transmits portions of the live content corresponding to URL1 to the sink device. If no data in the storage unit of the source device is left yet to be transmitted to the sink device, the source device changes the state of the live content corresponding to URL1 into a non-seekable or non-trick playable state, and informs the sink device of the change of the state of the live content corresponding to URL1 in operation 912 by transmitting an event message to the sink device. In operation 913, the sink device receives the event message from the source device, executes another ‘browse’/‘search’ command in order to obtain information on how the state of the live content corresponding to URL1 has been changed, and receives the information from the source device.

The live content management method according to the present invention, which is performed in the sink device or the source device according to the present invention, may be configured as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for configuring the processing methods can be easily construed by programmers skilled in the art to which the present invention pertains.

According to the present invention, it is possible to provide various data transmission scenarios for a home network environment by efficiently managing live content even when the transmission of the live content via a home network has been temporarily stopped.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A live content management method, which manages live content via a network, the live content management method comprising:
storing live content in a storage unit of a source device if transmission of the live content from the source device to a sink device is temporarily stopped.

2. The live content management method of claim 1 further comprising:
transmitting the live content stored in the storage unit of the source device to the sink device and then transmitting live content currently being broadcasted to the sink device via the storage unit of the source device, when receiving a request for resuming the transmission of the live content stored in the storage unit of the source device before a time-out for a command to stop the transmission of the live content stored in the storage unit of the source device.

3. The live content management method of claim 1 further comprising:
transmitting to the sink device information on whether the state of the live content stored in the storage unit of the source device has been changed.

4. The live content management method of claim 1 further comprising:
transmitting live content currently being broadcasted directly to the sink device when receiving a request for transmitting the live content currently being broadcasted after a time-out for a command to stop the transmission of the live content stored in the storage unit of the source device.

5. The live content management method of claim 4, wherein the request for transmitting the live content currently being broadcasted is transmitted using an HTTP GET command.

6. The live content management method of claim 1 further comprising:
transmitting the live content stored in the storage unit of the source device to the sink device and then transmitting live content currently being broadcasted to the sink device via the storage unit of the source device when receiving a request for transmitting the live content stored in the storage unit of the source device after a time-out for a command to stop the transmission of the live content stored in the storage unit of the source device.

7. The live content management method of claim 6, wherein the request for transmitting the live content stored in the storage unit of the source device is transmitted using an HTTP GET command with a predetermined range specified therein.

8. The live content management method of claim 7 further comprising:
transmitting an error message or the live content currently being broadcasted to the sink device if the live content stored in the storage unit of the source device is outside the predetermined range.

9. The live content management method of claim 1 further comprising:
transmitting the live content stored in the storage unit of the source device to the sink device by performing a trick play when receiving, from the sink device, a request for resuming the transmission of the live content stored in the storage unit of the source device after a time-out for a command to stop the transmission of the live content stored in the storage unit of the source device.

10. The live content management method of claim 9, wherein the transmitting the live content stored in the storage unit of the source device to the sink device, comprises:
receiving one or more HTTP GET commands with a range specified therein from the sink device and transmitting live content corresponding to the range to the sink device more than one time in response to the HTTP GET command(s).

11. The live content management method of claim 9, wherein the transmitting the live content stored in the storage unit of the source device to the sink device, comprises:
receiving an HTTP GET command with the trick play specified therein from the sink device and transmitting the live content stored in the storage unit of the source device by performing the trick play.

12. A live content management method, which manages live content via a network, the live content management method comprising:
issuing to a source device a request for temporarily stopping transmission of live content so that the transmission of the live content can be temporarily stopped and the live content can be stored in the source device.

13. The live content management method of claim 12 further comprising:
issuing to the source device a request for resuming the transmission of the live content stored in the source device before a time-out for a command to temporarily stop the transmission of the live content; and
receiving the live content stored in the source device in response to the request for resuming the transmission of the live content stored in the source device.

14. The live content management method of claim 12 further comprising:
receiving information on whether the state of the live content stored in the source device has been changed from the source device.

15. The live content management method of claim 12 further comprising:
issuing to the source device a request for transmitting live content currently being broadcasted after a time-out for a command to stop the transmission of the live content stored in the source device and receiving the live content currently being broadcasted directly from the source device.

16. The live content management method of claim 15, wherein the request for transmitting the live content currently being broadcasted is issued using an HTTP GET command.

17. The live content management method of claim 12 further comprising:
issuing to the source device a request for transmitting the live content stored in the source device after a time-out for a command to stop the transmission of the live content stored in the source device and receiving the live content stored in the storage unit of the source device and then live content currently being broadcasted from the source device.

18. The live content management method of claim 17, wherein the request for transmitting the live content stored in the source device is issued using an HTTP GET command with a predetermined range specified therein.

19. The live content management method of claim 18 further comprising:
receiving an error message or the live content currently being broadcasted from the source device if the live content stored in the storage unit of the source device is outside the predetermined range.

20. The live content management method of claim 12 further comprising:
issuing to the source device a request for transmitting the live content stored in the source device after a time-out for a command to stop the transmission of the live content stored in the source device and receiving the live content stored in the source device from the source device through a trick play.

21. The live content management method of claim 20, wherein the issuing to the source device the request for transmitting the live content stored in the source device, comprises:
transmitting one or more HTTP GET commands with a range specified therein to the source device and receiving live content corresponding to the range from the source device more than one time in response to the HTTP GET command(s).

22. The live content management method of claim 20, wherein the issuing to the source device the request for transmitting the live content stored in the source device, comprises:
transmitting an HTTP GET command with the trick play specified therein to the source device and receiving the live content stored in the source device from the source device through the trick play.

23. A source device which manages live content via a network, the source device comprising:
a controller, which stores live content in a storage unit of a source device if the transmission of the live content from the source device to a sink device is temporarily stopped.

24. The source device of claim 23, wherein the controller transmits the live content stored in the storage unit of the source device to the sink device and then transmits live content currently being broadcasted to the sink device via the storage unit of the source device when receiving, from the sink device, a request for resuming the transmission of the live content stored in the storage unit of the source device before a time-out for a command to stop the transmission of the live content stored in the storage unit of the source device.

25. The source device of claim 23, wherein the controller transmits live content currently being broadcasted to the sink device when receiving, from the sink device, a request for transmitting the live content currently being broadcasted after a time-out for a command to stop the transmission of the live content stored in the storage unit of the source device.

26. The source device of claim 23, wherein the controller transmits the live content stored in the storage unit of the source device to the sink device and then transmits live content currently being broadcasted to the sink device via the storage unit of the source device when receiving, from the sink device, a request for resuming the transmission of the live content stored in the storage unit of the source device after a time-out for a command to stop the transmission of the live content stored in the storage unit of the source device.

27. The source device of claim 23, wherein the controller receives one or more HTTP GET commands with a range specified therein from the sink device and transmits live content corresponding to the range to the sink device more than one time in response to the HTTP GET command(s).

28. The source device of claim 23, wherein the controller receives an HTTP GET command with the trick play specified therein from the sink device and transmits the live content stored in the storage unit of the source device by performing the trick play.

29. A sink device which manages live content via a network, the sink device comprising:
a controller, which issues to a source device a request for temporarily stopping the transmission of live content so that the transmission of the live content can be temporarily stopped and the live content can be stored in the source device.

30. The sink device of claim 29, wherein the controller issues to the source device a request for resuming the transmission of the live content stored in the source device before a time-out for a command to temporarily stop the transmission of the live content, and receives the live content stored in the source device.

31. The sink device of claim 29, wherein the controller issues to the source device a request for transmitting live content currently being broadcasted after a time-out for a command to stop the transmission of the live content stored in the source device and receives the live content currently being broadcasted directly from the source device.

32. The sink device of claim 29, wherein the controller issues to the source device a request for transmitting the live content stored in the source device after a time-out for a command to stop the transmission of the live content stored in the source device and receives the live content stored in the storage unit of the source device and then live content currently being broadcasted from the source device.

33. The sink device of claim 29, wherein the controller issues to the source device a request for transmitting the live content stored in the source device after a time-out for a command to stop the transmission of the live content stored in the source device and receives the live content stored in the source device from the source device through a trick play.

34. The sink device of claim 29, wherein the controller transmits one or more HTTP GET commands with a range specified therein to the source device and receives live content corresponding to the range from the source device more than one time in response to the HTTP GET command(s).
